(19) United States
(12) Patent Application Publication
(10) Pub. No.: US 2016/0105793 A1
(43) Pub. Date: Apr. 14, 2016

(54) MOBILE PHONE AND METHOD FOR AUTOMATICALLY UPDATING A CURRENTLY ACTIVE SYSTEM MODE OF A MOBILE PHONE

(71) Applicant: HON HAI PRECISION INDUSTRY CO., LTD., New Taipei (TW)

(72) Inventors: CHIA-HAO KANG, New Taipei (TW); LIANG-TE CHIU, New Taipei (TW)

(21) Appl. No.: 14/659,069

(22) Filed: Mar. 16, 2015

(30) Foreign Application Priority Data
Oct. 8, 2014 (TW) 103134961

(51) Int. Cl. H04W 8/22

(52) U.S. Cl. CPC H04W 8/22

(57) ABSTRACT

A computer-implemented method for updating a currently active system mode is disclosed. The method includes: receiving, from an electronic device at a mobile phone, a command that requests deactivation of a first mode and activation a second mode in the mobile phone, wherein the first mode is a currently active mode, and each of the first mode and the second mode includes at least one system parameter; determining, at the mobile phone, whether the first mode is consistent with the second; and deactivating, at the mobile phone, the currently active system mode and activating the second if the currently active mode is inconsistent with the second.

### FIELD

The subject matter herein generally relates to a mobile phone and a method for automatically updating current system settings of a mobile phone.

### BACKGROUND

Mobile phones are widely used. In general, a mobile phone can provide a plurality of selectable modes. Each mode includes a plurality of system settings, for example, volume of ringing strength, loudspeaker volume, screen luminance, and etc. The selectable modes are stored in a storage unit of the phone, and a user can manually selects a corresponding mode according to current environment. For example, when in a meeting, a mobile phone will be set to be silent.

### BRIEF DESCRIPTION OF THE DRAWINGS

Implementations of the present technology will now be described, by way of example only, with reference to the attached figures.

FIG. 1 is a diagrammatic view of an exemplary embodiment of a mobile phone.

FIGS. 2-3 are a flowchart of an exemplary embodiment of a method for automatically updating current system settings of a mobile phone.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The connection can be such that the objects are permanently connected or releasably connected. The term “comprising,” when utilized, means “including, but not necessarily limited to”; it specifically indicates open-ended inclusion or membership in the so-described combination, group, series and the like.

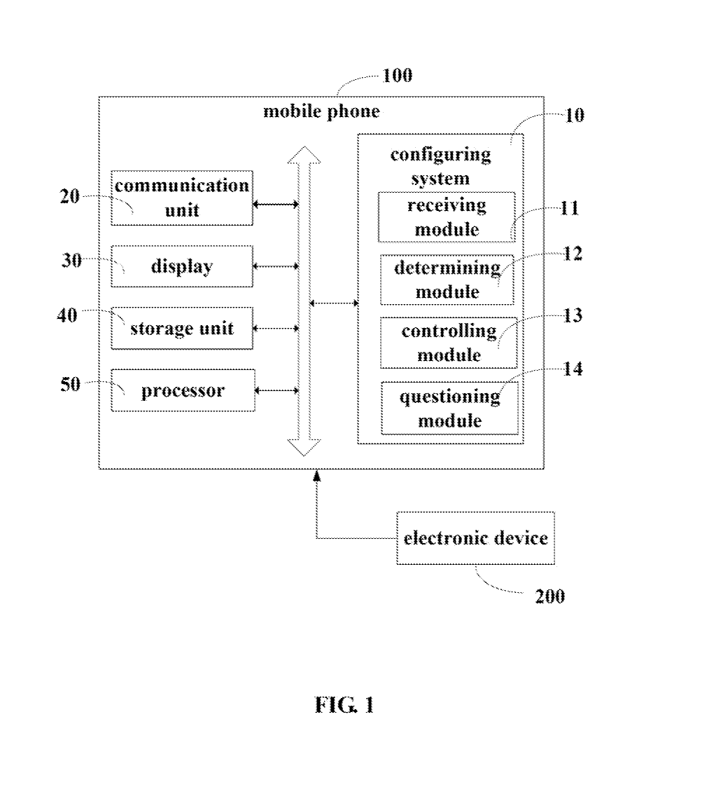

FIG. 1 illustrates diagrammatic view of an exemplary embodiment of a mobile phone 100. In the example embodiment, the mobile phone 100 can include a communication unit 20, a display 30, a storage unit 40, and a processor 50. The communication unit 20 can be configured to couple the mobile phone 100 to an electronic device 200 wirelessly. The electronic device 200 can be a computer, or a server, or other electronic device capable of transmitting commands. The communication unit 20 can be a Wi-Fi enabled module or a Bluetooth enabled module. The display 30 can be a light emitting diode (LED) screen. The storage unit 40 can be a storage system, such as a hard disk, a storage card, or a data storage medium. In at least one embodiment, the storage unit 40 can include two or more storage devices such that one storage device is a memory and the other storage device is a hard drive. Additionally, one or more of the storage devices can be located external relative to the computing device 1. The processor 50 can be a central processing unit (CPU), a microprocessor, or other data processor chip that performs functions of the mobile phone 100.

A system for automatically updating current mode 10 can include computerized instructions in the form of one or more programs that are executed by the processor 40 and stored in the storage unit 30. The system 10 can include one or more modules, for example, a receiving module 11, a determining module 12, a controlling module 13, and a questioning module 14. A “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The receiving module 11 can be configured to receiving a command that request to update currently active system mode of the mobile phone 100 from an electronic device. For example, at an entrance of a meeting room, the receiving module 11 can be configured to receive a command that requests to update currently active system mode from a first mode to be a second. The first mode can be a normal mode and the second mode can be suitable for a predefined situation. For example, the second mode can be a silence mode for a meeting room; at the exit of the meeting room, the receiving module 11 can be configured to receive a command that requests to update currently active system mode back to the first mode. The determining module 12 can be configured to determine whether the currently active system mode is consistent with the second. The controlling module 13 can be configured to update the currently active system mode according to the command. The questioning module 14 can be configured to question that whether a user agree to update the currently active system mode.

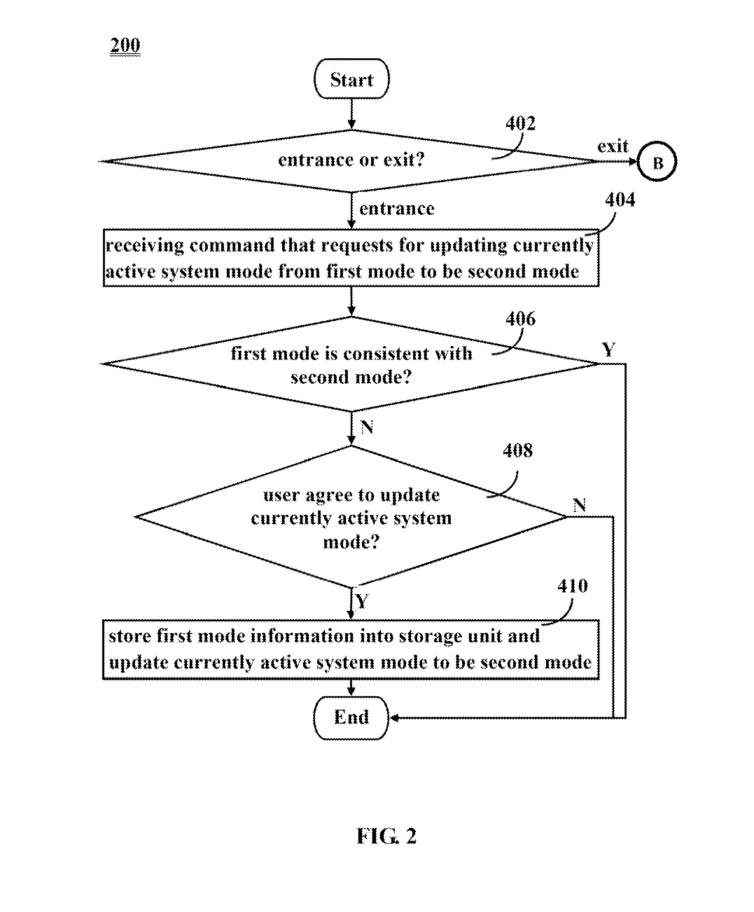

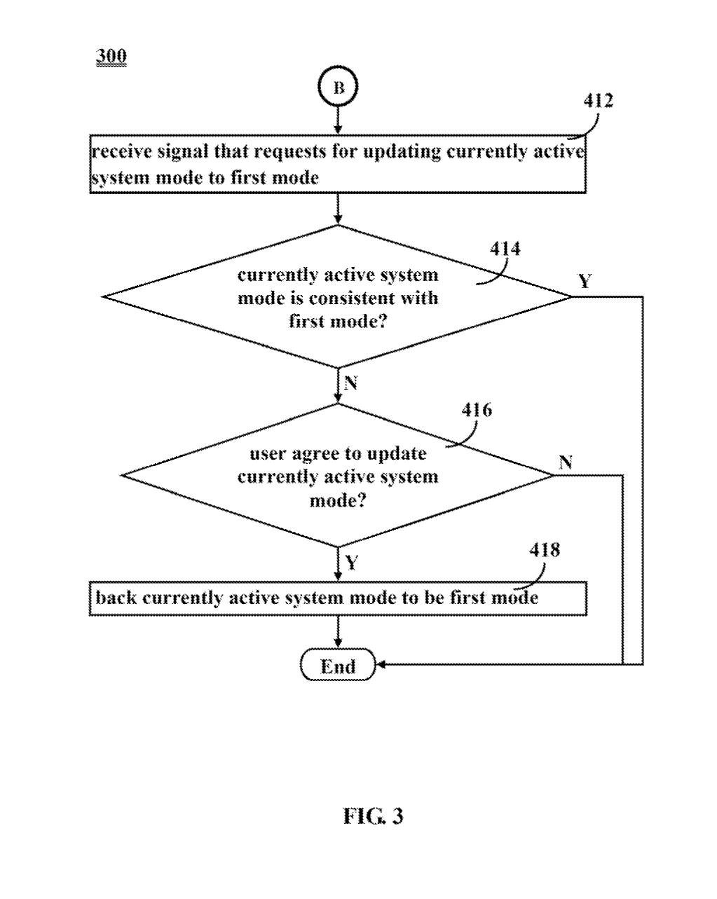

FIGS. 2 and 3 illustrate a flowchart in accordance with an example embodiment of a method for automatically updating currently active system mode of a mobile phone which is being thus illustrated. The example methods 200 and 300 are provided by way of example, as there are a variety of ways to carry out the method. The methods 200 and 300 described below can be carried out using the configurations illustrated in FIG. 1, for example, and various elements of these figures are referenced in explaining example methods 200 and 300. Each block shown in FIGS. 2 and 3 represent one or more processes, methods or subroutines, carried out in the exemplary method 300. Additionally, the illustrated order of blocks is by example only and the order of the blocks can change according to the present disclosure. The exemplary methods 200 and 300 for automatically updating currently active system mode of a mobile phone are illustrated in FIGS. 2 and 3. The exemplary methods 200 and 300 can begin at block 402.

At block 402, the mobile phone determines whether a user is going to enter into or leave from a destination, for example, a cinema, or a meeting room. In the embodiment, when the user arrived near the entrance of the destination, the mobile phone will receive a message that questions whether the user is going to enter into the destination. If receiving user's input indicating that the user is going to enter into the destination, the process goes to block 404; if receiving user's input indicating that the user is going to leave from the destination, the process goes to block 412 (referring to FIG. 3). In at least one embodiment, if the entrance and exit of the destination are located separately, the block 402 can be omitted.

At block 404, the mobile phone receives a command that requests to update currently active system mode of the mobile phone from a first mode to be a second mode. The first mode is suitable for a current situation, for example, on a street road. The second mode is suitable for a predefined situation. The mode of mobile phone can include a plurality of mode, for example, an out-door mode in which both vibration alert and ring alert are activated when a call coming, a normal mode in which only ring alert is activated when a call coming, a silent mode in which only vibration alert is activated when a call coming. The first mode can be applicable for a current situation, for example, on a street road. The second mode can be applicable for a predefined situation, for example, a meeting room or a classroom. In the embodiment, the destination can be a meeting room, the first mode can be the normal mode, and the second can be silent mode.

At block 406, the mobile phone determines whether the first mode is consistent with the second. If the first mode is not consistent with the second, the process goes to block 408, otherwise, the process goes to an end.

At block 408, the mobile phone determines whether the user agree to update the currently active system mode to be the second. If receiving a user input indicating that the user agrees to update the currently active system mode, the process goes to block 410, otherwise, the process goes to the end.

At block 410, the mobile phone stores the first mode information into a storage unit of the mobile phone and then updates the currently active system mode to be the second.

At block 412, the mobile phone receives a command that requests to update the currently active system mode of the mobile phone to be the first mode.

At block 414, the mobile phone determines whether the currently active system mode is consistent with the first mode. If the currently active system mode is not consistent with the first mode, the process goes to block 416, otherwise, the process goes to the end.

At block 416, the mobile phone determines whether the user agree to update the currently active system mode to be the first mode. If receiving a user input indicating that the user agrees to update the currently active system mode to be the first mode, the process goes to block 418, otherwise, the process goes to the end.

At block 418, the mobile phone updates the currently active system mode to be the first mode.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A computer-implemented method for updating a currently active system mode comprising:
receiving, from an electronic device at a mobile phone, a command that requests deactivation of a first mode and activation a second mode in the mobile phone, wherein the first mode is a currently active system mode, the second mode is applicable for a predefined situation, and each of the first mode and the second mode includes at least one system parameter;
determining, at the mobile phone, whether the first mode is consistent with the second; and
deactivating, at the mobile phone, the first mode and activating the second mode if the first mode is inconsistent with the second.

2. The method according to claim 1, further comprising storing the first mode information into a storage unit of the mobile phone.

3. The method according to claim 1, further comprising:
determining, at the mobile phone, whether the user agrees to deactivate the first mode and to activate the second mode; and
performing the deactivation and activation if the user agrees to deactivate the first mode and to activate the second mode.

4. The method according to claim 1, further comprising:
receiving, from the electronic device, a command that requests for deactivation of the second mode and activation of the first mode;
determining, at the mobile phone, whether the second mode is consistent with the first mode; and
deactivating, at the mobile phone, the second mode and activating the first mode if the second mode is inconsistent with the first mode.

5. The method according to claim 4, further comprising:
determining, at the mobile phone, whether the user agrees to deactivate the second mode and to activate the first mode; and
performing the deactivation of the second mode and activation of the first mode at the mobile phone, if the user agrees to deactivate the second mode and to activate the first mode.

6. A mobile phone, comprising:
a communication unit;
a storage unit for storing instructions;
a processor for executing the instructions to cause the mobile phone to:
receive from an electronic device a command that requests deactivation of a first mode and activation a second mode in the mobile phone, wherein the first mode is a currently active mode, the second mode is applicable for a predefined situation, and each of the first mode and the second mode includes at least one system parameter;
determine whether the first mode is consistent with the second mode; and
deactivate the first mode and activating the second mode if the first mode is inconsistent with the second mode.

7. The mobile phone according to claim 6, wherein the processor further causes the mobile phone to store the first mode information into a storage unit of the mobile phone.

8. The mobile phone according to claim 6, wherein the processor further causes the mobile phone to:
determine whether the user agrees to deactivate the first mode and to activate the second mode; and
the deactivation and activation if the user agrees to deactivate the first mode and to activate the second mode.

9. The mobile phone according to claim 6, wherein the processor further causes the mobile phone to:
receive, from the electronic device, a command that requests deactivation of the second mode and activation of the first mode;
determine whether the second mode is consistent with the first mode; and
deactivate the second mode and activate the first mode if the second mode is inconsistent with the first mode.

10. The mobile phone according to claim 9, wherein the processor further causes the mobile phone to:
determine whether the user agrees to deactivate the second mode and to activate the first mode; and
perform the deactivation of the second mode and activation of the first mode if the user agrees to deactivate the second mode and to activate the first mode.
